(19) United States
(12) Patent Application Publication
(10) Pub. No.: US 2005/0115496 A1
(43) Pub. Date: Jun. 2, 2005

(54) SUPPLY FOR DRY PARTICULATE MATERIAL

(75) Inventors: Jeffrey R. Shutic, Wakeman, OH (US); Donald L. Urig, Elyria, OH (US); Terrence M. Fulkerson, Brunswick Hills, OH (US); William R. Rehman, Vermillion, OH (US); Michael S. Thomas, Elyria, OH (US)

Correspondence Address: CALFEE, HALTER & GRISWOLD, LLP, 800 SUPERIOR AVENUE, SUITE 1400, CLEVELAND, OH, 44114, US

(73) Assignee: NORDSON CORPORATION, Westlake, OH (US)

(21) Appl. No.: 10/711,432

(22) Filed: Sep. 17, 2004

Related U.S. Application Data
(60) Provisional application No. 60/481,602, filed on Nov. 5, 2003.

(51) Int. Cl. B05C 5/00; B05B 7/00; B05C 19/00

(52) U.S. Cl. 118/308

(57) ABSTRACT

A material supply for a material application system such as a powder coating application system includes a feed hopper in the form of a duct. The duct is connectable to negative pressure during a color change process and is disconnected from the negative pressure during a spray application process. The negative pressure can be provided from a powder overspray recovery system such as an after filter blower. Dampers are provided to control air flow through the hopper duct and to allow the duct to be at ambient pressure during a supply mode of operation. The hopper duct also includes a suction interface for pumps, in the form of a siphon ring, as well as a fluidizing function. A removable sieve is provided with an optional vibration feature. Powder may be added to the duct via an access door or transfer pumps for new powder and/or reclaimed powder overspray.

### RELATED APPLICATIONS

This application claims the benefit of pending U.S. provisional patent application Ser. No. 60/481,602 filed on Nov. 5, 2003, for VIBRATORY SIEVE SCREEN WITH INTEGRAL MOTION GENERATOR the entire disclosure of which is fully incorporated herein by reference.

### TECHNICAL FIELD OF THE INVENTION

The invention relates generally to material application systems, for example, but not limited to, powder coating material application systems. More particularly, the invention relates to a material feed or supply for such systems that reduces cleaning time, color change time and improves ease of use.

### BACKGROUND OF THE INVENTION

Material application systems are used to apply one or more materials in one or more layers to an object. General examples are powder coating systems, as well as other particulate material application systems such as may be used in the food processing and chemical industries. These are but a few examples of a wide and numerous variety of systems used to apply particulate materials to an object and to which the present invention can find realization.

The application of dry particulate material is especially challenging on a number of different levels. An example, but by no means a limitation on the use and application of the present invention, is the application of powder coating material to objects using a powder spray gun. Because sprayed powder tends to expand into a cloud or diffused spray pattern, known powder application systems use a spray booth for containment. Powder particles that do not adhere to the target object are generally referred to as powder overspray, and these particles tend to fall randomly within the booth and will alight on almost any exposed surface within the spray booth. Therefore, cleaning time and color change times are strongly related to the amount of surface area that is exposed to powder overspray.

In addition to exterior surface areas exposed to powder overspray, color change times and cleaning are strongly related to the amount of interior surface area exposed to the flow of powder during an application process. Examples of such interior surface areas include all surface areas that form the powder flow path, from a supply of the powder all the way through the powder spray gun. The powder flow path typically includes a pump that is used to transfer powder from a powder supply to one or more spray guns. Hoses are commonly used to connect the supply, pumps and guns.

Interior surface areas of the powder flow path are typically cleaned by blowing a purge gas such as pressurized air through portions of the powder flow path. Wear items that have surfaces exposed to material impact, for example a spray nozzle in a typical powder spray gun, can be difficult to clean due to impact fusion of the powder on the wear surfaces.

Most powder spray application systems use a powder containment booth or spray booth in which the objects are sprayed. Powder overspray is collected by a powder recovery system, which typically operates on the basis of drawing a large volume of air from the spray booth, usually through openings in the walls or floor. This large air volume acts as containment air to prevent powder overspray from falling outside the spray booth. This containment air has entrained powder overspray which is separated from the containment air by a suitable device such as primary filters or cyclones. Since the primary filters or cyclones do not typically extract 100% of the entrained powder overspray, after filters are used to filter out residual powder from the air before venting to atmosphere.

Known supply systems for powder coating materials generally involve a container such as a box or hopper that holds a fresh supply of new or ‘virgin’ powder. This powder is usually fluidized within the hopper, meaning that air is pumped into the powder to produce an almost liquid-like bed of powder. Fluidized powder is typically a rich mixture of material to air. Often, recovered powder overspray is returned to the supply via a sieve arrangement. A venturi pump is used to draw powder through a suction line or tube from the supply into a feed hose and then to push the powder under positive pressure through the hose to a spray gun. Such systems are difficult to clean for a color change operation because the venturi pumps cannot be reverse purged, the suction tubes and associated support frames retain powder and changing the hoppers can be time consuming. The sieve is also challenging and time consuming to clean as it often is in a separate housing structure as part of the powder recovery system or is otherwise not easily accessible. Most of these components need to be cleaned by use of a high pressure air wand which an operator manually uses to blow powder residue back up into a cyclone or other powder recovery unit. Every minute that operators have to spend cleaning and purging the system for color change represents downtime for the system and inefficiency.

There are two generally known types of dry particulate material transfer processes, referred to herein as dilute phase and dense phase. Dilute phase systems utilize a substantial quantity of air to push material through one or more hoses from a supply to a spray applicator. A common pump design used in powder coating systems is the venturi pump which introduces a large volume of air at higher velocity into the powder flow. In order to achieve adequate powder flow rates (in pounds per minute or pounds per hour for example), the components that make up the flow path must be large enough to accommodate the flow with such a high air to material ratio (in other words lean flow) otherwise significant back pressure and other deleterious effects can occur.

Dense phase systems on the other hand are characterized by a high material to air ratio (in other words rich flow). A dense phase pump is described in pending U.S. patent application Ser. No. 10/501,693 filed on Jul. 16, 2004 for PROCESS AND EQUIPMENT FOR THE CONVEYANCE OF POWDERED MATERIAL, the entire disclosure of which is fully incorporated herein by reference, and which is owned by the assignee of the present invention. This pump is characterized in general by a pump chamber that is partially defined by a gas permeable member. Material, such as powder coating material as an example, is drawn into the chamber at one end by gravity and/or negative pressure and is pushed out of the chamber through an opposite end by positive air pressure. This pump design is very effective for transferring material, in part due to the novel arrangement of a gas permeable member forming part of the pump chamber. The overall pump, however, in some cases may be less than optimal for purging, cleaning, color change, maintenance and material flow rate control.

Many known material application systems utilize electrostatic charging of the particulate material to improve transfer efficiency. One form of electrostatic charging commonly used with powder coating material is corona charging that involves producing an ionized electric field through which the powder passes. The electrostatic field is produced by a high voltage source connected to a charging electrode that is installed in the electrostatic spray gun. Typically these electrodes are disposed directly within the powder path.

### SUMMARY OF THE INVENTION

The invention provides apparatus and methods relating to a feed or supply for material in a material application system. The invention is particularly useful in powder coating application systems, however, the invention will find utility in a wide variety of different particulate material application systems.

In accordance with one aspect of the invention, cleanability and color change times are substantially improved by a supply concept in which the functions of a hopper or container are combined with ductwork of a material recovery system. In one embodiment, a supply is provided having a container that is connectable to an after filter system that typically draws large volumes of air from a spray booth and an overspray recovery unit such as a cyclone. In a particular embodiment, the supply is in the form of a duct that is connectable to a recovery system. By having a supply that is connectable as a duct to the recovery system, cleaning is greatly simplified and faster. Preferably although not necessarily the hopper function includes fluidizing the material therein.

In accordance with another aspect of the invention, cleanability and color change times are substantially improved by a supply concept in which the functions of a hopper or container are combined with ductwork for a material recovery system so that negative pressure can be used during a cleaning and color change operation. In one embodiment, a hopper or supply is provided in the form of a duct that is selectively connectable to a source of negative pressure, such as for example, a material recovery system. The duct connection is arranged such that during a material application process the supply is substantially disconnected from the negative pressure source so that the supply operates generally at ambient air pressure.

In accordance with another aspect of the invention, a supply is contemplated that combines the functions of a hopper, suction tubes and optionally a fluidizing arrangement. In one embodiment, the hopper is in the form of a duct with a siphon ring and fluidizing plate at one end so that fluidized powder is extracted from the duct through one or more radial outlets in the siphon ring. Other embodiments include arranging the duct in selectable fluid communication with a recovery system. This greatly simplifies cleaning and color change by allowing the recovery system to remove most of the powder residue from the fluidizing hopper and siphon ring. In accordance with a further aspect of the invention, the siphon ring may be used as a source to a dense phase pump.

In accordance with another aspect of the invention, a fluidizing arrangement is contemplated that improves the mixing and fluidization of powder by providing a convective-like circulatory flow within a duct. In one embodiment, the fluidizing arrangement includes a fluidizing bed that is of larger diameter than the associated duct. This embodiment produces an increased vertical flow velocity near the outer portions of the fluidizing plate, in effect causing a circulating motion to the material, thereby improving mixing and re-mixing of material therein. In a more specific embodiment, a transition duct or ring that has an involute profile enhances the circulatory motion while providing a surface area that is easy to clean.

In accordance with another aspect of the invention, a supply is provided for a material application system which combines the functions of a hopper, suction tubes and fluidizing arrangement with duct work of a material recovery system. Such an arrangement allows for faster and simpler purging of the flow paths between the supply and the pumps, as well as faster and simpler cleaning of the hopper, fluidizing arrangement and powder extraction devices. In one embodiment, a hopper is realized in the form of a duct that is connectable to a recovery system, and also includes a fluidizing member and siphon ring. The siphon ring allows for pumps to access the fluidized material inside the duct.

In accordance with another aspect of the invention, a supply is provided for a material application system which combines the functions of a hopper and a fluidizing arrangement with ductwork of a material recovery system. In one embodiment, the fluidizing arrangement is releasable from the hopper which is in the form of a duct selectively connectable to the material recovery system.

In a further embodiment of all of the above, the siphon ring can be released from the duct during a normal cleaning or color change operation so that the fluidizing plate and siphon ring can be cleaned by air flow generated by the recovery system.

The invention will find application in dense phase and dilute phase material transport systems.

In accordance with another aspect of the invention, a sieve arrangement is provided that is easy to access and clean and has improved sieving action. This is achieved by a sieve design in which the sieve is manually accessible through an opening in a duct and is optionally provided with an integral vibration mechanism. In one embodiment, a sieve is provided inside a hopper in the form of a duct with the sieve being manually positioned for cleaning and sieving operations. In one embodiment, an inflatable seal is used to secure the sieve in its sieving position in a fluid tight manner but that can also be deflated for easy movement of the sieve to a cleaning position. In accordance with another aspect of the invention, the cleaning position of a sieve is located in or near the duct-like hopper so that during cleaning the residue powder is drawn up into a recovery system. In accordance with another aspect of the invention, a moveable sieve can be positioned within a duct-like hopper that is connectable to ductwork of a recovery system. The recovery system removes much of the powder residue on the sieve during a color change or cleaning operation. In still a further embodiment the sieve is provided with an integral vibration device.

The invention also contemplates the methods and steps embodied in the use of such above-described arrangements. Moreover, the invention contemplates cleaning and color change processes for a supply in which a recovery system is used to draw off most of the residue material, and an operator can finish cleaning the surfaces either with an air wand or other suitable device such as a fabric or cloth mitt.

These and many other aspects and advantages of the present invention will be apparent to those skilled in the art from the following description of the exemplary embodiments in view of the accompanying drawings.

### BRIEF DESCRIPTION OF THE DRAWINGS

FIG. 1 is a functional schematic of a material application system suitable for use with the present invention;

FIG. 2 is an isometric illustration of a material supply in accordance with the invention;

FIG. 3 is an exploded isometric of a fluidizing arrangement and support frame;

FIG. 4 is the assembly of FIG. 3 in longitudinal cross-section along the section line 4-4 in FIG. 3;

FIG. 5 is the assembly of FIG. 3 in longitudinal cross-section along the section line 5-5 in FIG. 3;

FIG. 6 illustrates a gasket arrangement for the fluidizing arrangement of FIG. 3, in cross-sectional perspective, enlarged for clarity;

FIG. 7 is a perspective illustration of the material supply in an operational position;

FIG. 7A illustrates a lance arrangement for drawing material from a box;

FIGS. 8A-8D illustrate a siphon ring in accordance with the invention, wherein FIG. 8A is a perspective from an top view, FIG. 8B is a section taken along the line 8B-8B in FIG. 8C, FIG. 8C is a bottom view and FIG. 8D is an enlarged view of the circled region of FIG. 8B;

FIG. 9 is a cross-sectional illustration of the interface between the siphon ring of FIGS. 8A-8D and the fluidizing unit of FIGS. 4-6, taken along the line 9-9 in FIG. 2;

FIG. 10 is a perspective of a supply in accordance with the invention installed in a material application system with portions of the system omitted for clarity;

FIG. 11 is another perspective of a supply in accordance with the invention installed in a material application system;

FIG. 12 illustrates a sieve arrangement in accordance with the invention in an operational position;

FIG. 13 illustrates the sieve arrangement of FIG. 12 in a cleaning or color change position;

FIG. 14 illustrates the sieve arrangement of FIGS. 12 and 13 in cross-section; and

FIG. 15 illustrates an alternative embodiment for the sieve arrangement.

### DETAILED DESCRIPTION OF THE INVENTION AND EXEMPLARY EMBODIMENTS THEREOF

The invention contemplates a number of new aspects and concepts for a supply that can be used with a particulate material application system. The supply may be used in combination with any number of spray applicator devices or spray guns, spray booths and pumps. The supply is particularly useful with dense phase transport, but may be used with dilute phase transport as well.

By “dense phase” is meant that the air present in the material flow is about the same as the amount of air used to fluidize the material at the supply such as a feed hopper. As used herein, “dense phase” and “high density” are used to convey the same idea of a low air volume mode of material flow in a pneumatic conveying system where not all of the material particles are carried in suspension. In such a dense phase system, the material is forced along a flow path by significantly less air volume as compared to a conventional dilute phase system, with the material flowing more in the nature of plugs that push each other along the passage, somewhat analogous to pushing the plugs as a piston through the passage. With smaller cross-sectional passages this movement can be effected under lower pressures and volumes of process air.

In contrast, conventional particulate flow systems for powder coating tend to use a dilute phase which is a mode of material flow in a pneumatic conveying system where all the particles are carried in suspension. Conventional flow systems introduce a significant quantity of air into the flow stream in order to pump the material from a supply and push it through under positive pressure to the spray application devices. For example, most conventional powder coating spray systems utilize venturi pumps to draw fluidized powder from a supply into the pump. A venturi pump by design adds a significant amount of air to the powder stream. Typically, flow air and atomizing air are added to the powder to push the powder under positive pressure through a feed hose and an applicator device. Thus, in a conventional powder coating spray system, the powder is entrained in a high velocity, high volume flow of air, thus necessitating large diameter powder passageways in order to attain usable powder flow rates.

Dense phase flow is oftentimes used in connection with the transfer of material to a closed vessel under high pressure. The present invention, in being directed to material application rather than simply transport or transfer of material, contemplates flow at substantially lower pressure and flow rates as compared to dense phase transfer under high pressure to a closed vessel.

As compared to conventional dilute phase systems having air volume flow rates of about 3 to about 6 cfm (such as with a venturi pump arrangement, for example), the present invention may operate at about 0.8 to about 1.6 cfm, for example. Thus, in the present invention, powder delivery rates may be on the order of about 150 to about 300 grams per minute.

Dense phase versus dilute phase flow can also be thought of as rich versus lean concentration of material in the air stream, such that the ratio of material to air is much higher in a dense phase system. In other words, in a dense phase system the same amount of material per unit time is transiting a cross-section (of a tube for example) of lesser area as compared to a dilute phase flow. For example, in some embodiments of the present invention, the cross-sectional area of a powder feed tube is about one-fourth the area of a feed tube for a conventional venturi type system. For comparable flow of material per unit time then, the material is about four times denser in the air stream as compared to conventional dilute phase systems.

The present invention is directed to a material supply arrangement and various improvements therein for use in a material application system.

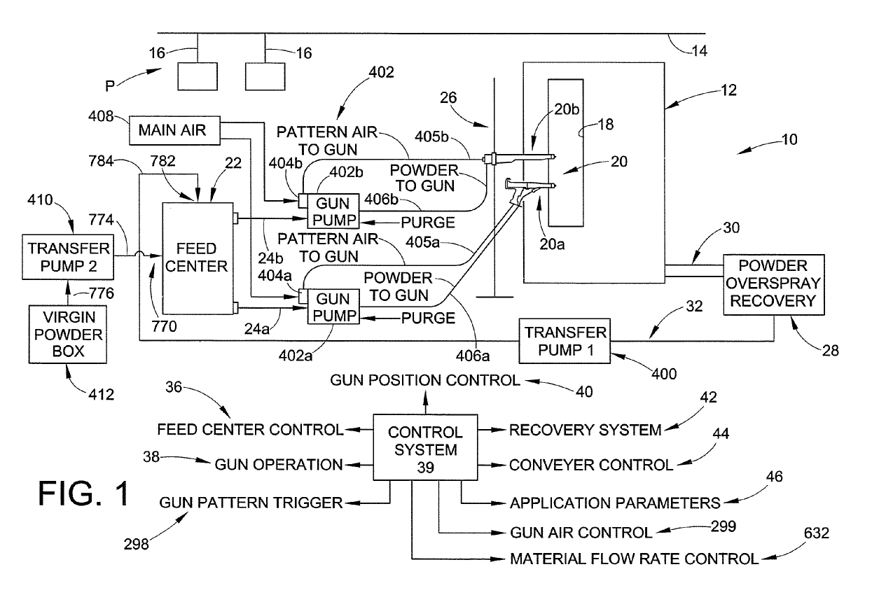

With reference to FIG. 1, in an exemplary embodiment, the present invention is illustrated being used with a material application system, such as, for example, a typical powder coating spray system 10. Such an arrangement commonly includes a powder spray booth 12 in which an object or part P is to be sprayed with a powder coating material. The application of powder to the part P is generally referred to herein as a powder spray, coating or application operation or process, however, there may be any number of control functions, steps and parameters that are controlled and executed before, during and after powder is actually applied to the part.

As is known, the part P is suspended from an overhead conveyor 14 using hangers 16 or any other conveniently suitable arrangements. The booth 12 includes one or more openings 18 through which one or more spray applicators 20 may be used to apply coating material to the part P as it travels through the booth 12. The applicators 20 may be of any number depending on the particular design of the overall system 10. Each applicator can be a manually operated device as in device 20a, or a system controlled device, referred to herein as an automatic applicator 20b, wherein the term “automatic” simply refers to the fact that an automatic applicator is mounted on a support and is triggered on and off by a control system, rather than being manually supported and manually triggered.

It is common in the powder coating material application industry to refer to the powder applicators as powder spray guns, and with respect to the exemplary embodiments herein we will use the terms applicator and gun interchangeably. However, it is intended that the invention is applicable to material application devices other than powder spray guns, and hence the more general term applicator is used to convey the idea that the invention can be used in many material application systems in addition to powder coating material application systems. Some aspects of the invention are applicable to electrostatic spray guns as well as non-electrostatic spray guns. The invention is also not limited by functionality associated with the word “spray”. Although the invention is especially suited to powder spray application, the pump concepts and methods disclosed herein may find use with other material application techniques beyond just spraying, whether such techniques are referred to as dispensing, discharge, application or other terminology that might be used to describe a particular type of material application device.

The spray guns 20 receive powder from a feed center or supply 22 through an associated powder feed or supply hose 24. The terms “feed center” and “supply” are used interchangeably herein to refer to any source of particulate material in accordance with the present invention. To the extent that the supply 22 mimics a feed hopper in the sense of being a container for powder, the supply 22 can be thought of and referred to as a hopper, but, the invention contemplates various design aspects of the supply 22 that are a significant advance over conventional hoppers used to supply powder to a powder spray application system.

The automatic guns 20b typically are mounted on a support 26. The support 26 may be a simple stationary structure, or may be a movable structure, such as an oscillator that can move the guns up and down during a spraying operation, or a gun mover or reciprocator that can move the guns in and out of the spray booth, or a combination thereof.

The spray booth 12 is designed to contain powder overspray within the booth, usually by a large flow of containment air into the booth. This air flow into the booth is usually effected by a powder overspray reclamation or recovery system 28. The recovery system 28 pulls air with entrained powder overspray from the booth, such as for example through a duct 30. In some systems the powder overspray is returned to the feed center 22 as represented by the return line 32. In other systems the powder overspray is either dumped or otherwise reclaimed in a separate receptacle.

In the exemplary embodiment herein, powder is transferred from the recovery system 28 back to the feed center 22 by a first transfer pump 400. A respective gun pump 402 is used to supply powder from the feed center 22 to one or more associated spray applicator or gun 20. For example, a first pump 402a is used to provide dense phase powder flow to the manual gun 20a and a second pump 402b is used to provide dense phase powder flow to the automatic gun 20b. The design of the gun pumps and transfer pumps may be any conveniently available or suitable design. Dense phase pumps, such as for example the pump described in the patent application noted hereinabove, or dilute phase pumps may be used.

Each gun pump 402 operates from pressurized gas such as ordinary air supplied to the gun by a pneumatic supply manifold 404. Although each manifold and pump assembly is schematically illustrated in FIG. 1 as being directly joined, it is contemplated that in practice the manifolds 404 will be disposed in a cabinet or other enclosure and directly mounted to the pumps 402 through an opening in a wall of the cabinet. In this manner, the manifolds 404, which may include electrical power such as solenoid valves, are isolated from the spraying environment.

The manifold 404 supplies pressurized air to its associated pump 402 for purposes that will be explained hereinafter. In addition, each manifold 404 includes a pressurized pattern air supply 405 that is provided to the spray guns 20 via air hoses or lines 406. Main air 408 is provided to the manifold 404 from any convenient source within the manufacturing facility of the end user of the system 10.

In this embodiment, a second transfer pump 410 is used to transfer powder from a supply 412 of virgin powder (that is to say, unused) to the feed center 22. Those skilled in the art will understand that the number of required transfer pumps 410 and gun pumps 402 will be determined by the requirements of the overall system 10 as well as the spraying operations to be performed using the system 10.

Other than the supply 22, the selected design and operation of the material application system 10, including the spray booth 12, the guns 20, the pumps 400, 402 and 410, the conveyor 14, and the recovery system 28, form no required part of the present invention and may be selected based on the requirements of a particular coating application. A control system 34 likewise may be a conventional control system architecture such as a programmable processor based system or other suitable control circuit. The control system 34 executes a wide variety of control functions and algorithms, typically through the use of programmable logic and program routines, which are generally indicated in FIG. 1 as including but not necessarily limited to feed center control 36 (for example supply controls and pump operation controls), gun operation control 38, gun position control 40 (such as for example control functions for the reciprocator/gun mover 26 when used), powder recovery system control 42 (for example, control functions for cyclone separators, after filter blowers and so on), conveyor control 44 and material application parameter controls 46 (such as for example, powder flow rates, applied film thickness, electrostatic or non-electrostatic application and so on). Conventional control system theory, design and programming may be utilized.

The control functions for gun operation 38 include but are not limited to gun trigger on and off times, electrostatic parameters such as voltage and current settings and monitoring, and powder and air flow rates to the guns. These control functions may be conventional as is well known.

While the described embodiments herein are presented in the context of a dense phase transport system for use in a powder coating material application system, those skilled in the art will readily appreciate that the present invention may be used in many different dry particulate material application systems, including but not limited in any manner to: talc on tires, super-absorbents such as for diapers, food related material such as flour, sugar, salt and so on, desiccants, release agents, and pharmaceuticals. These examples are intended to illustrate but not limit the broad application of the invention for dense phase application of particulate material to objects. The specific design and operation of the material application system selected provides no limitation on the present invention unless and except as otherwise expressly noted herein.

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sun-combinations are intended to be within the scope of the present invention. Still further, while various alternative embodiments as to the various aspects and features of the invention, such as alternative materials, structures, configurations, methods, devices, software, hardware, control logic and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

Even from the general schematic illustration of FIG. 1 it can be appreciated that such complex systems can be very difficult and time consuming to clean and to provide for color change. Typical powder coating material is very fine and tends to be applied in a fine cloud or spray pattern directed at the objects being sprayed. Even with the use of electrostatic technology, a significant amount of powder overspray is inevitable. Cross contamination during color change is a significant issue in many industries, therefore it is important that the material application system be able to be thoroughly cleaned between color changes. Color changes however necessitate taking the material application system offline and thus is a cost driver. The present invention is directed to providing a supply that is easier and faster to clean, and thus easier and faster to clean for a color change process. Additional features and aspects of the invention are advantageous separate and apart from the concern for cleanability and color change.

In accordance with the invention, a supply for material to a material application system is contemplated that dramatically improves cleanability and ease of use over conventional hopper and other container type designs, thereby also producing a dramatic improvement in color change time. These improvements derive from several unique combinations, sub-combinations and implementation of various functions that heretofore has been carried out separately in a material application system. These functions include, but are not necessarily limited to, a material container or hopper, a material recovery system, a fluidizing arrangement, a sieving arrangement and a suction interface between the container and one or more pumps. In prior systems, the implementation of these various functions led to various structural features and limitations that made cleaning and color change a rather time consuming and labor intensive undertaking. By implementing a drastic departure from conventional implementation approaches, the present invention provides a supply that is easier and faster to use and to clean, and can be used with dense phase and dilute phase transport processes.

Thus, in accordance with one aspect of the invention, a material supply is provided that is not a conventional container, such as a fluidizing box or hopper, but rather takes a form that facilitates cleaning the supply by an interface with a rather high volume air flow. The exemplary embodiments of the supply are realized in the form of a duct that can be connected and disconnected from a source of negative pressure, especially negative pressure associated with a high volume of air flow. One opening to the duct is available to the negative pressure source, and optionally another opening to the duct is releasably closed by a fluidizing arrangement. A suction interface is also optionally provided with the supply. Thus, the negative pressure air flow cleans not only the duct but also the fluidizing arrangement and the suction interface. The invention especially contemplates interfacing the supply to an air flow system that establishes containment air flow for the spray booth that originates from a material overspray recovery system such as a cyclone and/or filter recovery system. In the exemplary embodiment herein the supply duct is connectable to a filtered flow of air, in this case an after filter unit. In accordance with further aspects of the invention, the supply can optionally accommodate powder feed from a virgin supply, such as a conventional box, and from a recovery system, or both at the same time. Still further, the supply can optionally accommodate a removable sieving arrangement, also with an optional and integrated vibration function.

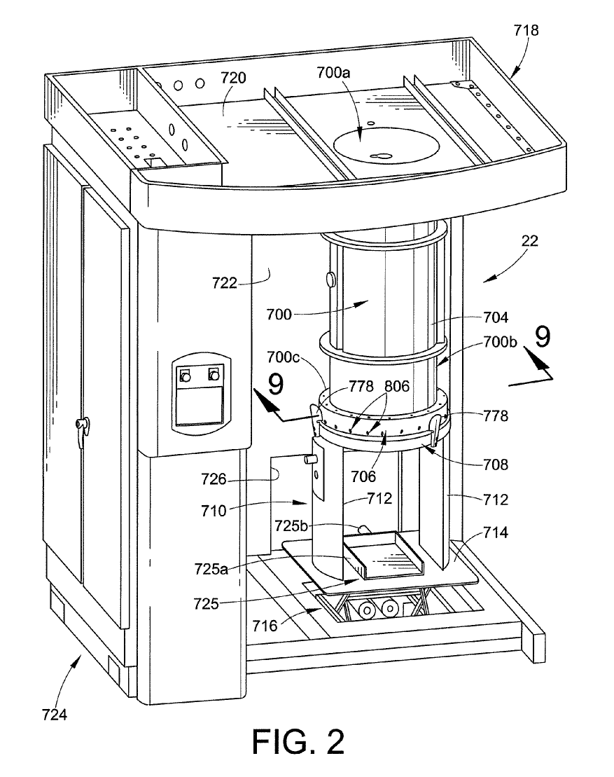

With reference to FIG. 2 then, a supply 22 in accordance with the present invention is illustrated without being fully interconnected to other functions of the material application system 10. The supply 22 (as used herein with respect to the invention, the words “supply 22” and “hopper 22” are used interchangeably) includes a main body or duct 700 that defines an interior volume 702 for holding powder coating material that will be applied to objects transported through the spray booth 12 (FIG. 1 ). In the exemplary embodiment the body 700 is generally cylindrical in form, although a cylinder is not required. A cylindrical form is preferred as it is easier to clean. But other profiles and shapes, including but not limited to frusto-conical receptacles, may be used as required.

An access door 704 is provided in the main body 700. The access door 704 is hinged and provides access to the interior region 702 of the body 700. This access door can be used by an operator to add powder manually to the system and can also be used for cleaning the interior surfaces of the supply 22. The door 704 also provides access to a sieve mounted within the body 700 as will be described in detail hereinafter. In FIG. 2 the door 704 conforms to the cylindrical shape of the main body 700, but any shaped door can be used. In other drawings herein, for example, a rectangular door can be provided or other shape as required.

In this example, the body 700 is formed by a cylindrical portion of sheet metal in the form of a duct. An upper end 700a of the duct is open and is connectable to duct work associated with a powder recovery system, as will be further described herein. A lower portion 700b of the duct has a siphon ring 706 mounted thereto. The siphon ring 706 sealingly engages a fluidizing unit 708 and functions as a suction interface between the supply 22 and the pumps 400, 402 and 410. The fluidizing unit 708 is mounted on a support frame 710 that has two legs 712. The support frame 710 is mounted to a platen 714 that is secured to a lifting mechanism 716. The lifting mechanism 716 operates to raise and lower the platen 714 and hence the fluidizing unit 708 into and out of sealing contact with the bottom of the siphon ring 706. The design of the lifting mechanism 716 in this example is a scissors-like mechanism, but any suitable arrangement can be used to effect a vertical lifting and lower function of the frame 710 and fluidizing unit 708.

The supply 22 may be disposed within a supporting structure 718 that includes a ceiling 720 that secures the upper end 700a to provide a mounting frame for attachment to additional ductwork as will be described hereinafter. A rear wall 722 serves to partially enclose the structure 718, and a large bay 724 is provided on one side of the structure. The bay 724 can be used to enclose various support components of the spray application system, including in this example electronics and pneumatic controls associated with the gun and transfer pumps 20. An equalization duct opening 726 is provided in the rear wall 722. When the supply 22 is connected into the overall system, as illustrated in additional drawings herein, a containment air flow is produced through the opening 726 that can be used during a color change operation to prevent powder from escaping the interior of the structure 718. Containment air also flows up into the duct 700 as well as the cyclone during a cleaning operation.

At this point it is noted that the supply 22 has two basic operational modes. The first is referred to herein as the supply mode or hopper mode. In this mode, the supply 22 is arranged such that the duct 700 is substantially disconnected from the material recovery system and is in sealed contact with the fluidizing arrangement 708 (via the siphon ring 706.) The supply 22 thus has a configuration in the supply mode much like a container that holds fluidized powder that is sucked out of the container by operation of the pumps. In the supply mode, the lower opening 726 is in fluid communication with the surrounding atmosphere so that the supply 22 operates generally at ambient pressure. In the exemplary embodiments herein the supply 22, when being used in the supply mode, is isolated from negative pressure by virtue of the upper damper being closed, the lower damper being open to balance pressure across the duct 700, and the presence of the transfer pump 400 between the cyclone output and the supply 22 (the pump 400 thus functioning among other things as an isolation device between the supply 22 and the negative pressure of the cyclone.

The other operational mode of the supply 22 is a cleaning mode or color change mode. In this mode, the supply 22 is arranged such that the duct 700 is in fluid communication with the material recovery system (e.g. the after filter unit) and the siphon ring 706 (which is mounted to the duct 700) is separated from the fluidizing unit 708. This allows air to enter the duct to remove by suction powder that is in the duct and on the siphon ring and fluidizing bed, as well as to facilitate cleaning the suction ports by reverse purging the pumps.

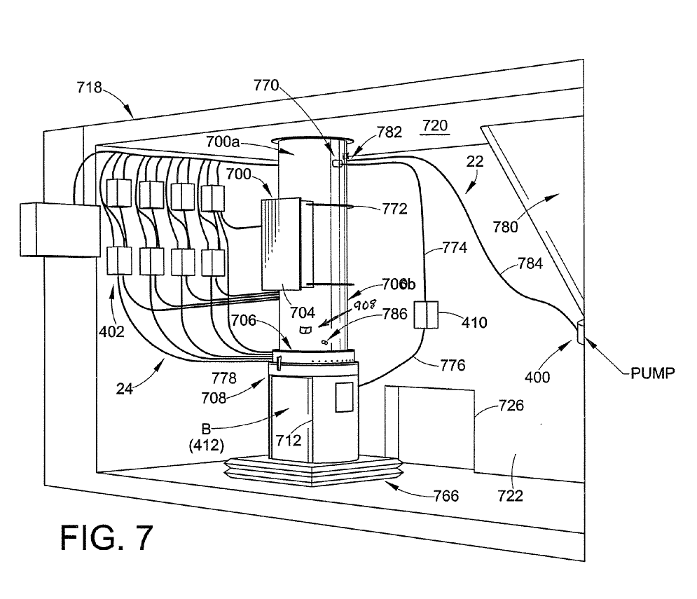

The frame 710 includes an open space between the legs 712. This space is provided so that an operator can position a box of virgin powder coating material (see FIG. 7) onto the platen 714 and under the fluidizing unit 708. This arrangement provides for an easy to reach location for a box of virgin powder coating material, but there is no requirement that the virgin powder supply be positioned immediately with the supply 22, because the transfer pump 410 is used to transfer powder from the box or container to an upper portion of the supply 22 as is later described hereinafter in more detail. But, having the powder box or container near the supply enables the air flow through the opening 726 produced by the powder recovery system to contain powder from the box from flowing outside of the structure 718. This location also allows powder to be dumped from the supply 22 during a color change operation. A separate or different box could also be used as required.

An optional box vibration unit 725 may be mounted on the platen 714. The vibration unit 725 typically includes a support frame 725a and a vibration inducing device 725b as is well known.

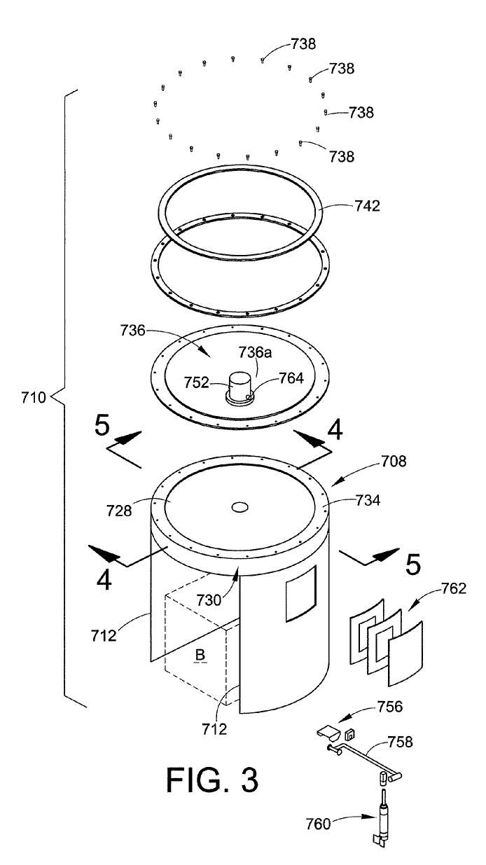

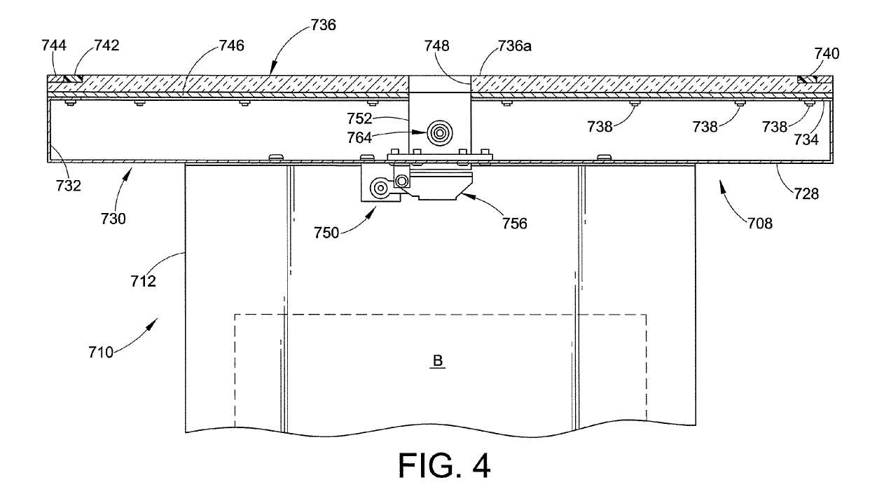

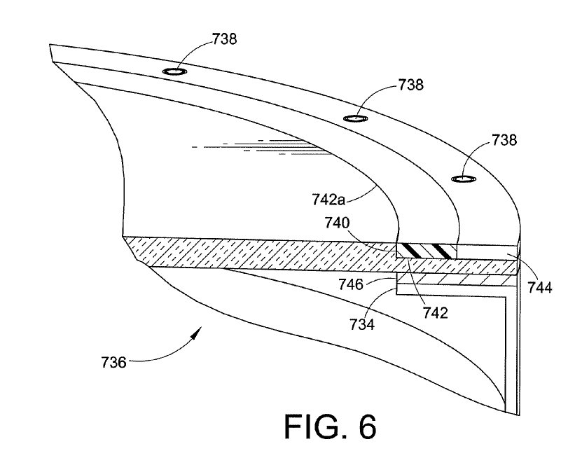

With reference to FIGS. 3, 4, 5 and 6, the legs 712 of the support frame 710 are attached to a bottom plate 728 of the fluidizing unit 708. The fluidizing unit 708 includes a plenum 730 which includes the lower plate 728 and an upwardly extending ring 732 that is provided with an inwardly extending lip 734. The lip 734 provides an annular surface to which a fluidizing member 736 is attached, such as for example, by bolt arrangements 738. The fluidizing member 736 is made of air permeable material that does not allow the powder material to pass through. The fluidizing member 736 thus may be made of the same material as conventional fluidizing plates, such as for example, partially sintered thermoplastic such as polypropylene available from Porex Technologies. The fluidizing member 736 preferably although not necessarily is a somewhat dish shaped plate having an inwardly and downwardly directed slope towards the center region 736a thereof. This slight taper or slope assists powder to fall towards the central region 736a and maintain a fluidized condition during a cleaning or color change operation.

The fluidizing member 736 includes a peripheral recess portion 740 that receives along its inner edge an annular gasket 742. The gasket 742 is held in place by an adhesive. A retainer ring 744 that secures the fluidizing member 736 to the plenum 730 as by the bolts 738. Preferably the gasket 742 includes a generally flat upper surface 742a that is flush or nearly flush with the upper surfaces of the fluidizing plate 736 and the retainer ring 744. This upper surface of the gasket 742 engages with a seal surface of the siphon ring as will be further described hereinafter. Another annular gasket 746 provides a fluid tight seal between the plenum 730 and the fluidizing member 736. The plenum 730 is thus a air tight box into which pressurized air is introduced through an appropriate fitting (not shown). This pressurized air is forced up through the permeable fluidizing member 736 and fluidizes powder that is present in the interior volume of the siphon ring 706 and lower regions of the cylinder 700.

With the fluidizing unit 730 (which includes the plenum, the fluidizing member and the upper exposed siphon ring gasket) integrally mounted on the support frame 710, the fluidizing unit can be raised and lowered into and out of sealed contact with a lower seal surface of the siphon ring 706, by operation of the vertically moveable platen 714.

A central drain hole 748 is provided in the fluidizing bed member 736. During a color change or cleaning operation fluidized powder will flow down through this hole 748 to a dump valve assembly 750. The dump valve assembly 750 may be any convenient design, and may be manually operated or under control of an actuator member. In this exemplary embodiment, the dump valve assembly 750 includes a drain 752 that extends from the fluidizing member drain hole 748 through the bottom plate 728 of the plenum 730. A face gasket or other suitable seal device 754 is used to seal the plenum and trap around the drain hole 748. The drain 752 prevents powder from getting into the plenum 730 interior. A gasketed valve cap 756 is used to selectively open and close the drain 752. The cap 756 is hinged so that it can open in response to actuation of a lever 758. This actuation lever 758 may be operated by a control actuator 760 such as a linear piston type actuator, or other suitable mechanism. An access door 762 is provided so that an operator can have manual access to the actuator 760. When the valve cap 756 is pivoted away from the drain 752, fluidized powder will drain into the box or other container B positioned between the support legs 712 of the frame 710. This allows most of the powder that falls onto the fluidizing plate 736 to be dumped to the box just prior to initiating a color change or cleaning process. The dumped powder can be dropped into a virgin powder supply box B (also labeled 410 in the drawings) or any other suitable container below the drain 752 for disposal or removal as needed.

One or more sealed air inlets 764 are provided in the drain 752. These inlets are used as purge ports to initially clear unfluidized powder from the drain 752 by injecting pressurized air into the trap to remove residue powder from the trap during a color change or cleaning process.

FIG. 7 illustrates the supply 22 in an exemplary operational position. A boot 766 covers the lifting mechanism 716 to prevent stray powder from getting into the mechanism and acts as a safety guard. The platen 714 may include the vibration device so as to prevent powder inside the box B from compacting. The transfer pump 410 (see FIG. 1 also) is used to transfer powder from the box B into a new powder inlet 770 provided in an upper region 700a of the duct 700 via a powder hose 774. The pump 768 draws powder from the box B through another powder hose 776 that may be, for example, connected to a lance that is inserted into the box. FIG. 7A shows the lance 900 in more detail. The hose 776 would be connected by a coupling member 902 to the lance 900 by O-rings (not shown) or other suitable connectors. Hose 776 and lance 900 would have the same internal diameter. The lance would be inserted into the powder contained within box 412 through the top layer 904 of the powder. Box 412 would be supported by a vibrator 906 to facilitate drawing the powder from the box through the lance 900 and hose 776 into transfer pump 410. During color change, the lance would be inserted through a collar 908 of the lower duct portion 700b. The collar 908 would be capped during our normal operation and only uncapped during the color change process when the lance is inserted into the collar. During the color change process, the powder coating material on the outside of the lance 900 will be drawn off by the air flow through the duct. Alternatively, powder can be blow off the outside of the lance by an air wand similar to the way the sieve is cleaned as described herein. When the lance is inserted into collar 908 during the color change operation, any powder remaining within the interior of the hose 776 and lance 900 will be purged into the duct.

Although not visible in FIG. 7, a sieve is provided, at the mounting flange 772, between the upper region 700a and a central region 700b of the duct body 700. New powder is pumped above the sieve so as to mix with reclaimed powder as will be described hereinafter. The door 704 however can be used for manually adding virgin powder to the supply 22, which is added below the sieve.

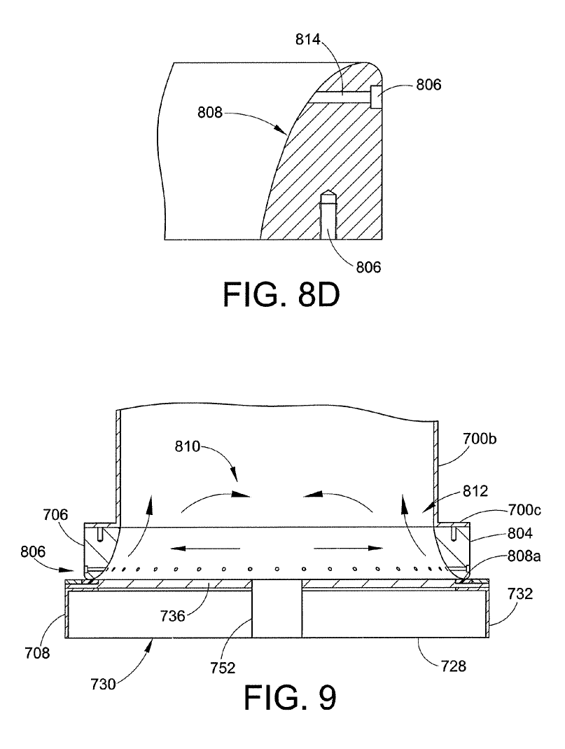

The lifting mechanism 716 is used to securely push the fluidizing unit 708 up against the bottom of the siphon ring, in the position illustrated in FIG. 9. The lifting mechanism 716 maintains the fluidizing unit against the siphon ring when the supply is in the supply mode configuration. Clamps 778 or other suitable devices may be used to tightly hold the siphon ring 706 against the fluidizing unit 708 in the case of a loss of lift pressure.

FIG. 7 further shows a series of pumps 402 which are used to transfer powder from within the siphon ring 706 to associated spray application devices such as spray guns 20 (FIG. 1). The pumps 402 may be conventional in design, and preferably although not necessarily are dense phase pumps. Typically there will be one pump per spray application device. As shown in FIG. 1, each pump has an associated powder hose 24 that connects the pump to an outlet in the siphon ring 706 in the supply 22.

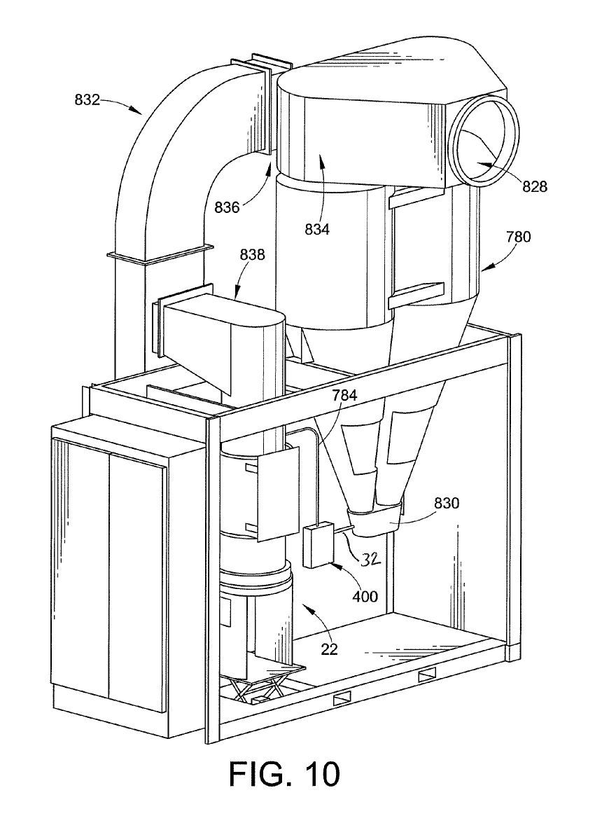

Reclaimed powder can also be introduced into the supply 22. This powder is recovered powder overspray from the spray booth 12 (FIG. 1). In the exemplary embodiment, air entrained powder is drawn into a cyclonic separator 780 that functions as part of the powder overspray recovery system 28 (the cyclone is partially shown in FIG. 7). Separated powder falls through the cyclone 780 into a pan or bin 830 (see also FIG. 10) where it is transferred by the transfer pump 400 through a first hose 32 to a second or reclaimed powder inlet 782 in the upper region 700a of the supply duct 700 via another hose 784.

In the operational position of FIG. 7, powder is introduced into the duct 700 through any one or combination of the access door 704 (manual addition), the new powder inlet 770 (virgin powder via transfer pump 410) or the second inlet 782 (reclaimed powder via transfer pump 400). When the powder enters the upper region 700a of the supply duct 700, it is sieved before falling to the fluidizing unit 708. The gun pumps 402 draw the powder from the siphon ring 706 and pump it to the spray application devices 20. Conventional level sensors 786 may be provided in the vicinity of the siphon ring 706, for example, to detect when powder needs to be added. The control system 39 (FIG. 1) as part of the feed center control function 36 monitors the level sensors 786 and operates the transfer pumps 400, 410 to add powder as needed to the supply duct 700.

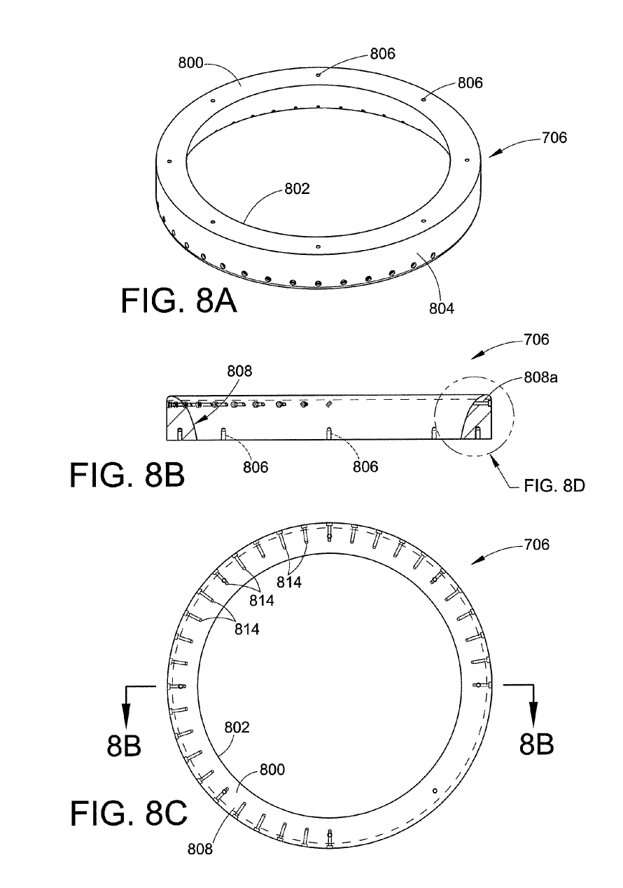

With reference to FIGS. 8A-8D and FIG. 9, in accordance with another aspect of the invention, the suction interface and function may also be incorporated into the new supply 22 concept. In the exemplary embodiment, the siphon ring 706 is used to provide a device by which the gun pumps 402 can draw fluidized powder out of the supply 22. Gun pumps, whether dense phase or dilute phase, draw powder from a supply by application of a negative pressure to a hose or tube that connects the pump inlet to the powder source. The siphon ring 706 in the exemplary embodiment thus provides a suction interface between the pumps and the fluidized powder swirling within the duct 700 so that the fluidized powder can be drawn out for spraying. The siphon ring 706 can also be reverse purged to help clean the overall supply, as will be further described hereinafter.

The siphon ring 706 includes an upper generally planar mounting surface 800 formed by a radially inwardly extending flange 802 that extends from a cylindrical outer side wall 804. The flange 802 includes a series of mounting holes 806 that allow the siphon ring 706 to be bolted or otherwise mounted on a flange extension 700c of the lower duct portion 700b (see FIGS. 2 and 9). The siphon ring 706 also is formed with an internal profile or geometry defined by the curved surface 808 about its internal periphery. In the exemplary embodiment the surface 808 is defined by an involute such that there is a constantly changing radius to the surface relative to a reference point. However, an involute profile is not required, and other curved or non-curved surface profiles may be used.

A lowermost portion 808a of the siphon ring sealingly contacts the gasket 742 of the fluidizing unit 708 when the fluidizing unit is raised to the position illustrated in FIG. 9. This position is the configuration of the supply 22 when operated in the supply mode.

In accordance with one aspect of the invention, the fluidizing function is enhanced to improve fluidizing and mixing of the powder coating material. The invention contemplates the use of the fluidizing bed member 736 having a diameter that is greater than the diameter of the duct 700. Air flows from the plenum 730 upward through the porous fluidizing bed. The fluidizing bed produces a diffused flow of air across its entire surface, which ventilates through powder through a decreasing volume presented by the transition between the fluidizing bed and the duct 700. This transition causes a higher air flow velocity, like an updraft, at the outer portion of the fluidizing bed. This outer portion is generally defined by the perimeter portion of the fluidizing bed that is radially greater than the outside diameter of the duct 700. The high air flow velocity updraft in this perimeter region produces a suction effect generally across the surface of the fluidizing bed that draws powder radially outward from a central region to the perimeter region. The powder is drawn upward along the outside portion of the siphon ring and the inside wall of the duct 700b, and by gravity and head pressure within the duct 700 the powder then flows across towards the center region and then back downwardly in the central region of the duct and siphon ring. Thus, a circulating, somewhat like a convective flow pattern, is produced within the lower region of the duct 700 and the siphon ring, as represented by the arrows 810 in FIG. 9. This circulatory flow pattern significantly improves the fluidization and mixing of the powder.

The circulating flow can be realized with generally any transition profile between the fluidizing bed and the duct 700. However, in accordance with another aspect of the invention, by providing the involute or other smooth transition profile to the interior perimeter of the siphon ring, there are no entrapment areas within the fluidizing zone, wherein the fluidizing zone can generally be understood as the volume within the lower portion of the duct 700b and within the volume of the siphon ring wherein air is used to fluidize the powder. The smoothly curved profile of the siphon ring, such as by using an involute for example, presents a single continuous surface having any number of recessed or flush suction ports formed therein (for coupling to pumps) with no entrapment areas within the fluidizing zone. The lack of entrapment areas is further effected by locating the suction ports 814 (FIGS. 8B and 8D) near the bottom of the siphon ring, just above the upper surface of the fluidizing bed.

When the fluidizing bed is lowered, such as during a color change operation, an operator can easily blow off or wipe off the siphon ring and duct without any irregular surfaces to clean. Much of the residual powder is sucked up from these surfaces by air flow up through the duct 700 and the equalization duct 832 (the equalization duct 832 acts as an exhaust duct for residue powder when the supply 22 is operating in the cleaning mode). In this mode, with the fluidizing bed lowered, air flow also follows up along the siphon ring inner surface and flows in a laminar manner up the sides of the duct 700 to help clean out the duct 700.

Thus, other curved or non-curved profiles for the siphon ring interior surface 808 may be used, particularly if the interior profile of the duct is not cylindrical. Preferably the surface 808 blends with a smooth transition as at 812 to the interior surface of the duct 700b.

By providing the fluidizing bed member 726 with an enlarged diameter relative to the duct 700, the head of powder in the duct 700 does not change drastically even if a substantial amount of powder is added to the supply 22, thereby minimizing any adverse impact on flow rate and uniformity of the powder to the applicators.

A series of radial through bores 814 are provided and generally, although not necessarily, are equally spaced about a portion of the siphon ring. Each bore 814 includes a counterbore 816 that serves as a powder suction port and is adapted to receive one end of a pump suction hose 24 and/or an appropriate hose connector (see FIGS. 2 and 7). These ports are preferably located near the bottom of the ring 706 so that the material application system can operate with as low a material supply as possible to quicken color change.

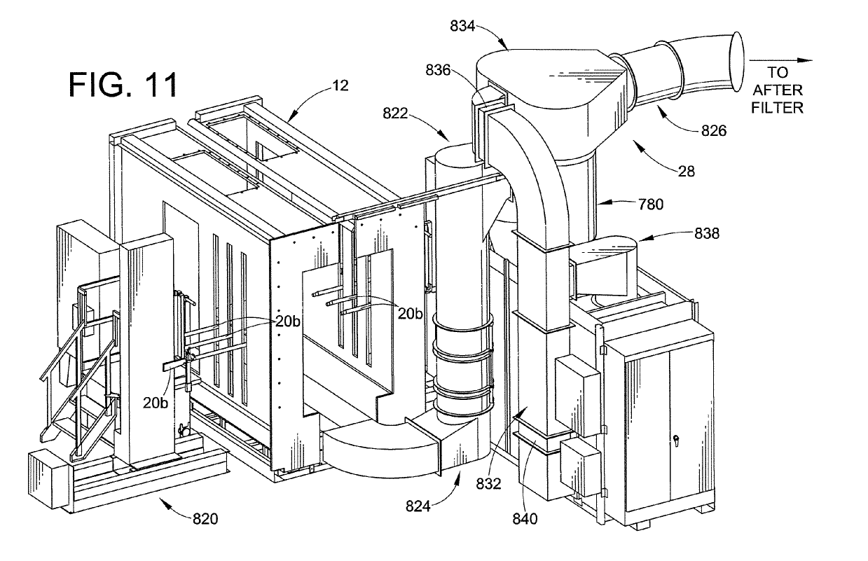

With reference to FIGS. 10 and 11, the material application system 10 can include a number of components including the spray booth 12, the automatic spray guns 20b mounted on a gun mover 820, and a powder overspray recovery system 28, which in the exemplary embodiments includes a twin cyclone separator 780. The spray guns 20b extend into the spray booth through openings or gun slots 18. The cyclones receive powder entrained air at a cyclone inlet 822 via a recovery duct 824 that is in fluid communication with the booth interior. In this example, overspray powder is drawn into the recovery duct 824 by a large air flow created by an after filter blower system (not shown). These blowers move large amounts of air through an exhaust duct 826 that is in fluid communication with an exhaust outlet 828 from the cyclones 780. The after filters provide final filtering of the cyclone exhaust air. The air drawn through the cyclones pulls powder entrained air from the spray booth into the cyclone inlet where the cyclonic operation separates the powder from the air. The recovered powder falls down into the lower portion of the cyclone to a bin or other receptacle 830 where it is transferred by the transfer pump 400 over to the supply 22 through the powder recovery hose 784 as described herein above.

In accordance with another aspect of the invention, the supply 22 is optionally connectable to a source of negative pressure, preferably accompanied by high air flow. In the exemplary embodiment, this aspect of the invention is realized by providing a duct that interconnects the supply 22 with the duct work of the powder recovery system. This allows the high air flow from the recovery system, such as the after filter blowers, to help clean powder from the duct 700 (and the supply 22 in general) and associated components. This concept is dramatically different from prior powder supply arrangements in which there was no direct connection like that shown between the supply hopper or box and the recovery system.

In accordance with the invention, an equalization duct 832 is provided between the lower opening 726 near the supply 22 and a banjo housing 834. The banjo 834 is simply a duct that provides a common plenum for the dual stack exhausts (not shown) from the twin cyclones. In a single cyclone system the equalization duct 832 can be simply connected into the duct work of the recovery system at any convenient location, typically downstream from the cyclone exhaust port. A first damper 836 is positioned between the equalization duct 832 and the banjo 834. Another duct 838 connects the duct 700 of the supply 22 to the equalization duct 832. In this manner, the negative pressure of the recovery system 28 can be used to produce a high flow of air through the supply 22, including the duct 700 and the siphon ring during a cleaning and/or color change operations. This is also referred to herein as the supply 22 being used in the cleaning mode.

A second or lower damper 840 is provided in the equalization duct 832 above the opening 726. This damper can be a simple two position damper, namely open and closed positions. The damper 840 is closed when the supply 22 is being cleaned or during color change, and is fully open when the supply 22 is being used in the hopper or supply mode. When closed, the damper 840 isolates the opening 726 from the suction force of the after-filter fan. The lower damper is re-opened during the final step of a color change procedure to clean out the partially enclosed supporting structure 718 so that residual powder can be exhausted through the opening 26 or up the cyclone.

The upper damper 836 is preferably a three position damper for reasons that will be explained hereinafter. In one position, the upper damper is fully closed so as to isolate the duct 700 from the negative pressure of the recovery system. This is the normal damper position during a powder application process for which the supply 22 is being used in the supply mode to supply powder to the pumps 402. It is possible that the damper 836 might not completely isolate the supply 22 from the negative pressure of the recovery system 28. Accordingly, the equalization duct 832 is used to provide a pressure balance across the duct 700 during use of the supply 22 in the supply mode. Thus, in the supply mode the supply 22, and particularly the duct 700 and siphon ring operate generally at ambient atmospheric pressure, meaning the atmospheric pressure of the surrounding environment of the material application system 10. This is accomplished by having the lower damper 840 fully open. The equalization duct 832 also provides additional make up air into the duct 700 for the pumps 402 because the fluidization air may not be enough for the pumps to adequately draw powder out of the siphon ring 706. During the cleaning mode, the equalization duct acts as an exhaust duct between the supply 22 and the recovery systems, namely the after filter unit in this embodiment.

Although the upper damper may typically be fully closed during a material application process (i.e. the supply 22 operating in the supply mode), it is possible to partially open the upper damper 836 during a material application process. The lower damper is also open. Opening the upper damper partially provides just enough air flow up through the duct 700 so that the door 704 can be opened without powder flowing out of the duct 700. With the door open during fluidization and suction of powder within the supply 22, an operator can observe the fluidization as well as operation of the sieve located in the upper portion of the duct 700 (described hereinafter). The upper duct can be opened just enough so that the flow of air up the duct 700 contains powder within the duct without adversely impacting the fluidization and suction functions in the fluidization zone of the supply 22.

When a color change or cleaning process is to be performed, the lower damper 840 is fully closed. The after filter blowers are on thereby drawing substantial air flow through the cyclone and through the duct work associated with the supply 22, as well as the duct work associated with the spray booth. With the upper damper partially opened, the platen 714 is lowered about an inch to separate the fluidizing unit 708 from the siphon ring 706. Then the upper damper is fully opened to allow for a substantial air flow to be drawn up into the siphon ring 705 and the duct 700 through the gap created between the fluidizing unit and the siphon ring. This air flow not only removes residue powder within the duct 700 but also cleans off the fluidizing plate and the interior surfaces of the siphon ring. At the same time, the siphon ring can be reverse purged by forcing air back through the bores 814 into the ring interior and up through the duct 700. The reverse air flow can be effected by a purging operation associated with the pumps 402 for example or by any other suitable technique.

When the initial cleaning has been completed, the platen 714 is fully lowered so that all the siphon ring/gasket 804/742 contact points can be visually inspected and wiped down or blown off as needed. The upper damper 836 is still fully opened so that maximum air continues to flow through the duct 700 and out to the recovery system such as the after filter unit.

Accordingly, a significant advantage of this aspect of the present invention is that the supply 22 is connectable to the recovery system to greatly increase the speed of cleaning and color change yet with a simple arrangement requiring significantly reduced labor. Another advantage is that the supply 22 can be, if so desired, physically distant from the cyclone because there is no need to use the cyclone to capture residue powder cleaned from the system. This greatly increases the flexibility in design and layout of the material application system 10 because the supply 22 can be located at its own convenient location on the shop floor regardless of the location of the cyclone. The cyclones can also be positioned much lower to the shop floor since the box or supply need not be positioned there under.

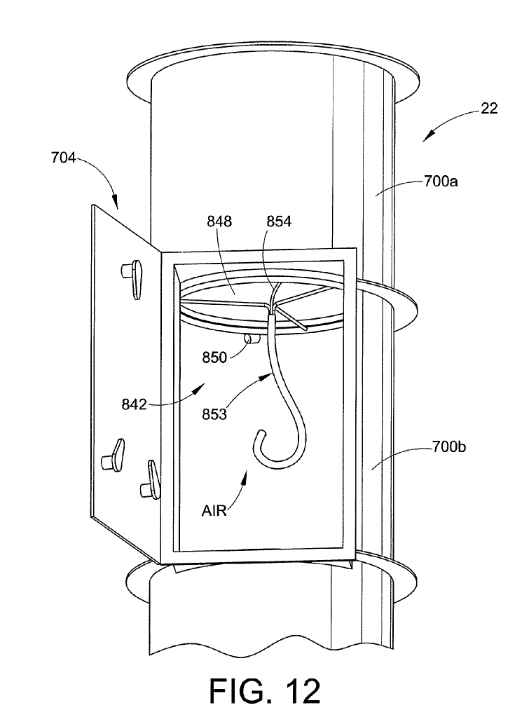

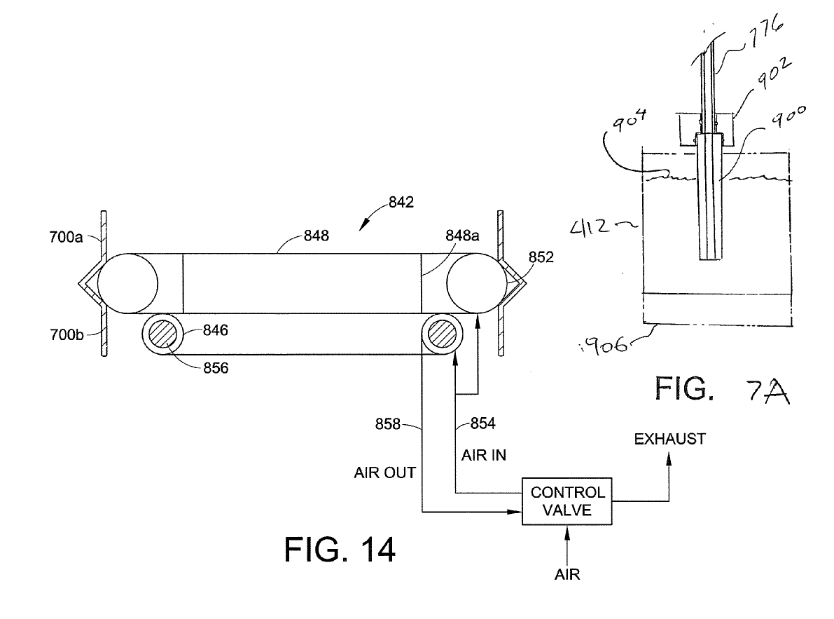

FIGS. 12, 13 and 14 illustrate an embodiment of another aspect of the invention. In accordance with this aspect, a sieving arrangement is contemplated in which the sieve has an integral expandable seal and an integral vibration function. The integrated vibration function produces vibration in the sieve arrangement itself only and not the rest of the supply 22 such as the duct 700.

In the exemplary embodiment, the sieve arrangement 842 is designed to be installed in the duct 700, between the upper portion 700a into which virgin and reclaimed powder is added (as described hereinabove) and the lower portion 700b (see FIG. 7). This location provides adequate volume for powder to be added and sieved prior to falling into the fluidizing zone of the duct 700, wherein the fluidizing zone is generally defined as the volume above the fluidizing plate 736 and generally but not necessarily completely within the siphon ring 706. The sieving function not only provides a more consistent feed of material into the fluidizing zone but also helps to uniformly mix the reclaimed and virgin powder, particularly when the vibration function is added to the sieve.

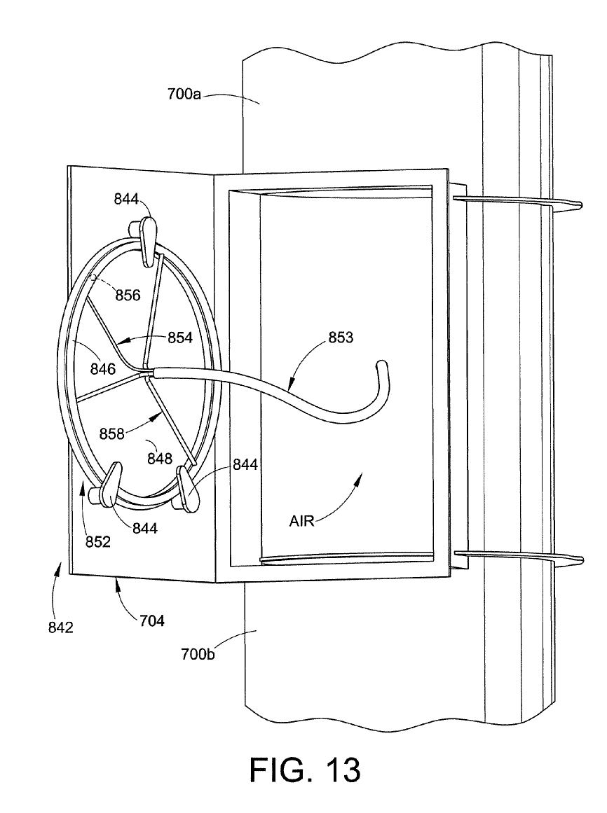

The sieve arrangement 842 preferably can be manually positioned as illustrated in FIGS. 12 and 13, and can be reached by an operator through the access door 704. The access door 704 may be provided with hooks or other suitable devices 844 for holding the sieve arrangement 842 during cleaning. Alternatively the sieve could be provided with a hanging device or one can be optionally installed by the operator each time the sieve is cleaned. During the cleaning mode, substantial air is being drawn into the duct 700 through the door opening 704a, therefore, an operator can use an air wand to blow residue off the sieve and into the duct 700. Note also that with the door 704 open the operator can use a mitt or air wand or other suitable cleaning device or combination thereof to finish cleaning the duct 700 interior during a cleaning or color change process.

The sieve arrangement 842 includes a hollow ring 846 that can be made of any suitable material, including metal, plastic, composite and so on. The ring 846 supports a sieve screen 848 so that the assembly can be installed inside the duct 700 by resting on compliant support pegs 850. An inflatable/deflatable seal device 852 is provided about the periphery of the sieve screen 848 such as within a groove of a screen frame 848a. An air hose 854 is in fluid communication with the seal 852 and is also connected to a source of air pressure (not shown) outside the duct 700 through an opening in the duct wall. The air lines for the sieve are contained within an umbilical 853. The umbilical 853 can alternatively be used to also enclose an ultrasonic energy source for supplemental vibration energy for the sieve. A valve or other control device (not shown) can be provided to allow an operator to inflate or deflate the seal 852. With the sieve in place up inside the duct 700 and resting on the pegs 850, the operator adds air into the seal 852 to expand it. The seal engages the inside wall of the duct 700. The screen seal 852 has the effect of not only installing the sieve in a fluid tight manner within the duct (so that all powder must pass through the sieve screen 848 and not around its perimeter) but it also is a compliant mount that centers the sieve screen within the duct. The seal 852 also dampens the sieve vibrations from being coupled into the duct 700.

To remove the sieve arrangement for cleaning, the operator simply deflates the seal 852, manually grasps the sieve 842 and hangs it on the door 704 outside of the duct 700 for cleaning. In this embodiment, the umbilical 853′ may include a quick disconnect arrangement (not shown) so that the entire sieve arrangement hangs from the door and can be easily cleaned off.

The hollow ring 846 has one or more elements inside, such as for example a ball bearing 856. Pressurized air is also injected into the ring 846 through one or more tangential air jets so as to impart motion to the elements 856 which induces vibration into the ring 846 and sieve screen 848. Air may be provided from a branch of the seal air line 854 or separately provided. The ring 846 thus functions as a race for the ball bearing 856. The motion air is exhausted from the ring 846 through an exhaust line 858 and can be exhausted to atmosphere or other locations in the system 10 that uses a pressurized air source. The ball diameter is slightly less than the inside diameter of the tube 846 so that air pressure will force the ball to spin around the inside of the ring. Supplemental energy may also be provided for vibrating the sieve. For example, ultrasonic energy may also be used in addition to the motion induced vibration.

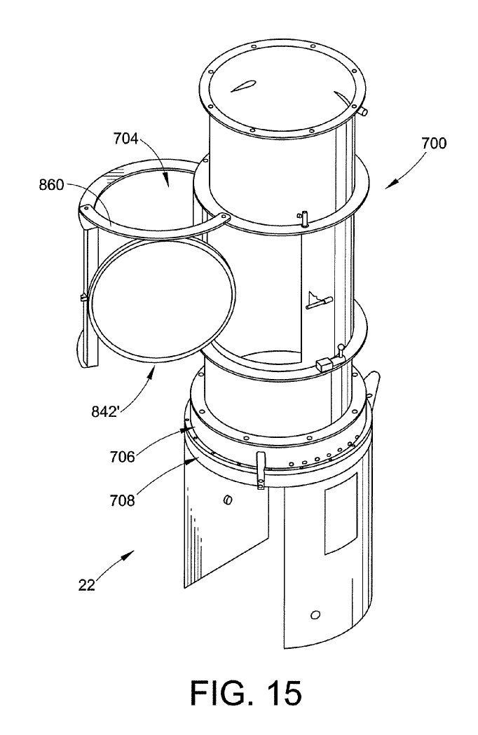

FIG. 15 illustrates an alternative embodiment of the sieve arrangement as used with a door that conforms to the cylindrical shape of the duct 700. In this embodiment, a strut 860 is associated with the door 704′. In this embodiment, the sieve arrangement 842′ is designed to be hung on the strut 860 when the door is open. The strut swings out with the door and swings back out of the way when the door is closed.

The various features of the supply 10 and associated components provide a fast and simple supply design to clean and for color change. An exemplary color change process will now be described, it being understood that this process can be used for cleaning as well as for color change, and that the particular order of the steps is not necessarily required and that various steps may be optional depending on the overall performance requirements of the material application system.

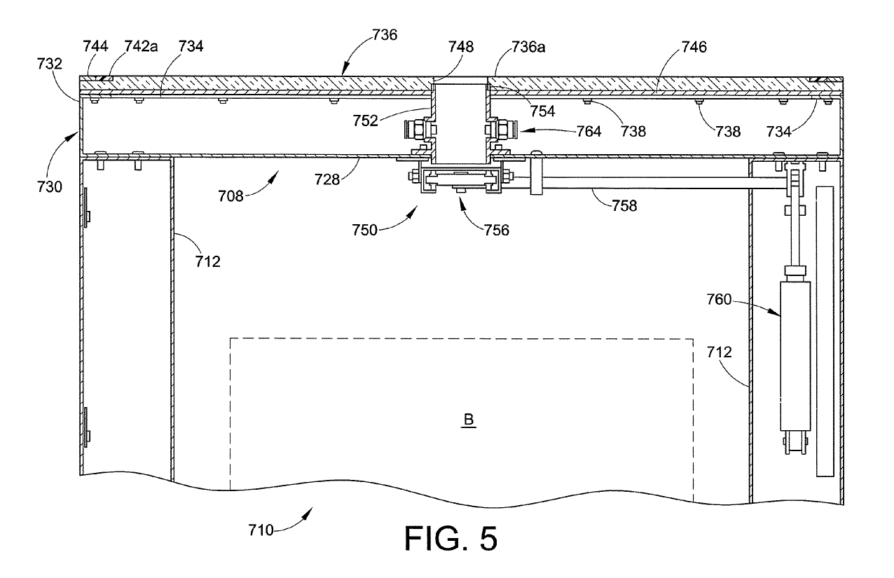

Presuming that the system 10 has been operational during a powder application process, when the spray applicators and pumps are turned off there may be a significant amount of powder still in the duct 700 and the siphon ring 706. The after filter blowers stay on and the fluidizing air to the fluidizing unit 708 remains on. The upper damper 836 is partially opened and the lower damper 840 is fully closed. The dump valve 756 is opened and much of the powder on the fluidizing plate falls down into the box B. The air being drawn into the duct 700 via the upper damper 836 and the ducts 832, 838 also removes powder from inside the duct 700 and the siphon ring and fluidizing unit. The gun pumps 402 and transfer pumps 400, 410 may optionally be reverse purged so that air blows through the radial ports in the siphon ring to clean the ports and help clean the siphon ring, as well as cleaning out the hoses that connect the gun pumps to the siphon ring and the transfer pumps to the duct 700. Air is also fed into the drain 752 (FIG. 5) to keep powder from remaining in the trap and also to clean the opening 748 in the fluidizing plate 736. The dump valve 750 is closed and the box can be removed. The platen 714 is then lowered a small amount, for example about one inch, to break the fluid tight seal between the fluidizing unit and the siphon ring. Then the upper damper is fully opened and air is drawn into the duct 700 through this small gap and cleans powder from the siphon ring as well as the fluidizing plate. This air flow also back washes the sieve screen 848 (initial air flow when the upper damper is first partially opened also sucks up powder that had remained on top of the sieve screen).

After an appropriate amount of time, such as for example about 10 seconds or so, the plate 714 is completely lowered. Not all of the after filter air however is pulled through the supply 22. Some of the after filter containment air still is pulled through the cyclone to prevent cyclone contamination into the supply duct 700 or into the partially enclosed supporting structure 718.

The operator opens the access door and can use an air wand, a mitt or other cleaning devices or combinations thereof to finish cleaning any small amount of powder that still may be inside the duct 700, the siphon ring and the fluidizing unit. This powder is easily drawn up into the duct 700 and out to the recovery system due to the large air flow. The operator also removes the sieve by deflating the seal and hangs the assembly on the door (or alternatively the strut) so that the air wand can be used to finish blowing off any residue powder on the sieve arrangement. Also, the sieve seal 852 can be cycled between inflated and deflated states, for example about every three seconds, to further dislodge powder from the seal. This also allows an operator to observe proper operation of the inflatable seal. The sieve then is repositioned up into the duct 700. The operator can then clean down the cyclone as needed and as is well known. After final cleaning is done, the lower damper may be closed and the upper damper partially closed. The platen 714 is raised so that the fluidizing unit re-engages the siphon ring. A new box of material can then be positioned under the fluidizing unit and the system is then ready to go back online (the upper damper will then be fully closed before starting the next material application process.)

By having the supply 22 connectable into the recovery system, cleaning and color change is much faster and easier because the large air flow can be used as an integral part of the cleaning operation even when the supply 22 is positioned remote from the cyclone. One operator is able to clean the supply and cyclone and provide color change in a matter of minutes with little effort and almost no tools. This arrangement also improves the purging and cleaning of the pumps and associated equipment.

As a still further alternative embodiment, it will be appreciated by those skilled in the art that the supply 22 lower works, including a lower portion of the duct 700, the siphon ring 706, the fluidizing unit 708 and the supporting structure and moveable platen 714, can be positioned directly under the cyclone outlet, particularly if a single cyclone is used. This configuration allows the supply 22 to be exhausted through the cyclone to the after filter, rather than using the additional duct work described in the exemplary embodiment herein above. In most cases, this configuration would utilize a vortice breaker between the cyclone and the supply 22 so as to minimize adverse affects, if any, of the cyclone operation on the fluidization and suction functions of the supply 22. Operation of the supply 22 would be substantially the same as the exemplary embodiment herein.

The invention has been described with reference to the preferred embodiment. Modifications and alterations will occur to others upon a reading and understanding of this specification and drawings. The invention is intended to include all such modifications and alterations insofar as they come within the scope of the appended claims or the equivalents thereof.

1. A supply for material used in a material application system, comprising:
a duct having a first end connectable to a material recovery apparatus;
said duct having a second end that is closed by a fluidizing member;
at least one material inlet to said duct interior; and
at least one material outlet for fluidized material from said duct interior through which material can be provided to a material applicator during a material application process;
said duct being disconnected from said material recovery apparatus during a material application process.

2. The supply of claim 1 wherein said material recovery apparatus produces a negative pressure within said duct when connected thereto.

3. The supply of claim 2 wherein said material recovery apparatus comprises an after filter unit for a powder coating application system.

4. The supply of claim 1 wherein said fluidizing member is releasable from said duct second end.

5. The supply of claim 1 comprising a siphon ring that joins said duct second end to said fluidizing member; said material outlet being provided in said siphon ring.

6. The supply of claim 1 wherein said duct comprises a generally cylindrical member having a diameter, said siphon ring having a diameter that is greater than said duct diameter.

7. The supply of claim 5 wherein said siphon ring comprises an interior surface formed as an involute.

8. The supply of claim 1 wherein during a material application process said duct is at ambient air pressure.

9. A supply for material used in a material application system, comprising:
a duct having an open first end and a second end that is closed by a fluidizing member;
at least one material inlet to said duct interior; and
at least one material outlet for fluidized material from said duct interior through which material can be provided to a material applicator during a material application process;
said duct being generally at ambient air pressure during a material application process.

10. A supply hopper for powder coating material used in a powder coating material application system, comprising:
a duct having a first open end and a second end that is closed by a fluidizing member;
at least one powder inlet to said duct interior; and
at least one powder outlet for fluidized powder from said duct interior through which powder can be provided to a powder spray applicator during a powder application process;
said duct being generally at ambient air pressure during a powder application process.

11. A supply hopper for powder coating material, comprising: a duct having an open first end and a second end closed by a fluidizing member;
a sieve positioned in said duct and being manually moveable between first and second positions; said second position being where said sieve is cleanable and said first position being where said sieve is in position to sieve powder that enters said duct through an inlet.

12. The hopper of claim 11 wherein said sieve comprises a ring that carries an inflatable seal so that when said sieve is in said first position said seal can be inflated to secure said sieve in said duct in a fluid tight manner.

13. The hopper of claim 11 wherein said sieve comprises a member with a vibration element therein; said vibration element traveling within said member under force of air pressure.

14. A supply for material used in a material application system, comprising:
a duct, a fluidizing device and a suction device, said fluidizing device and suction device being disposed at one end of the duct to form a receptacle for material, said suction device having at least one port therein through which material is drawn out of said duct.

15. The supply of claim 14 wherein said fluidizing device is mounted on a moveable support so that it can be positioned in sealing engagement with said duct for a supply mode of operation and can be positioned out of sealing engagement with said duct for a cleaning mode of operation.

16. The supply of claim 15 wherein said suction device comprises an annular ring that is attached to said one end of the duct, said ring having a lower surface that contacts a seal surface on said fluidizing device when the supply operates in the supply mode.

17. The supply of claim 16 wherein said suction device comprises a siphon ring having a contoured interior geometry.

18. The supply of claim 17 wherein said geometry comprises an involute.

19. The supply of claim 14 wherein said fluidizing member has a diameter that is greater than a diameter of said duct.

20. The supply of claim 19 wherein said port is positioned close to said fluidizing member.
